(19) United States
(12) Patent Application Publication
(10) Pub. No.: US 2025/0229540 A1
(43) Pub. Date: Jul. 17, 2025

(54) LIQUID STORAGE CONTAINER

(71) Applicant: CANON KABUSHIKI KAISHA, Tokyo (JP)

(72) Inventors: SHIGEKI FUKUI, Kanagawa (JP); HITOSHI TAKADA, Kanagawa (JP); HIROKI HAYASHI, Kanagawa (JP)

(21) Appl. No.: 19/018,151

(22) Filed: Jan. 13, 2025

(30) Foreign Application Priority Data
Jan. 17, 2024 (JP) 2024-005270

(51) Int. Cl. B41J 2/175

(52) U.S. Cl. CPC B41J 2/1754; B41J 2/17559

(57) ABSTRACT

A liquid storage container includes a storage member having a storage unit for storing a liquid and a supply unit for supplying the liquid stored in the storage unit to an outside, and a protective member capable of being assembled to one end portion of the storage member, wherein the protective member contains a recycled plastic material or a resin material mixed with a recycled plastic material, and has an opening configured to expose the supply unit, and wherein as the liquid storage container is viewed from a side on which the supply unit is provided, a central portion of a first side surface that is farthest from the supply unit exposed through the opening among side surfaces of the protective member has a convex shape in a direction farther away from the supply unit than an end portion.

### BACKGROUND OF THE INVENTION

### Field of the Invention

The present disclosure relates to a liquid storage container in which a liquid such as ink can be stored.

### Description of the Related Art

From the viewpoint of environmental consideration, various products are manufactured using recycled plastic materials. In order to realize a sustainable society such as a carbon-free/recycling-based society, it is preferable to shift to recycled plastic materials as much as possible for parts that can be guaranteed to function without using new plastic materials (hereinafter, also referred to as “virgin materials”). On the other hand, there is an issue with using recycled plastic materials for molding that molded products made of recycled plastic materials may deliver poor impact absorption performance when they are dropped and crashed. In particular, the influence is large when recycled plastic materials are used for large-capacity liquid storage containers for inkjet recording apparatuses (liquid discharge apparatuses).

Recycled plastic materials are made from raw ingredients that have experienced some degree of deterioration due to the thermal history during molding, stress, heat, and light during use, solvents, and the like. It is known that under these circumstances, the physical properties of recycled plastic materials differ from those of virgin materials. For example, recycled plastic materials tend to become degraded in impact absorption properties of the molecular chains inside the material that bend to absorb the impact. This tendency can be observed by Charpy impact tests, and molded materials containing recycled plastic materials show lower impact strength than virgin materials. This degradation in impact absorption properties is due to the fact that the original molecular chains have been cut due to the above-described experienced deterioration, and the impact absorbing effect of the molecular chains has been reduced.

Japanese Patent Application Laid-Open No. H10-16249 discusses a structure for providing sufficient rigidity to an ink cartridge body molded from a soft synthetic resin material. Specifically, the ink cartridge body has ridges at the corners of the peripheral wall and thick opening edges, and the lid has a longitudinal ridge and a protrusion on the inner surface.

### SUMMARY OF THE INVENTION

According to an aspect of the present invention, a liquid storage container includes a storage member having a storage unit for storing a liquid and a supply unit for supplying the liquid stored in the storage unit to an outside, and a protective member capable of being assembled to one end portion of the storage member, wherein the protective member contains a recycled plastic material or a resin material mixed with a recycled plastic material, and has an opening configured to expose the supply unit, and wherein as the liquid storage container is viewed from a side on which the supply unit is provided, a central portion of a first side surface that is farthest from the supply unit exposed through the opening among side surfaces of the protective member has a convex shape in a direction farther away from the supply unit than an end portion.

According to another aspect of the present invention, a liquid storage container includes a storage member having a storage unit for storing a liquid and a supply unit for supplying the liquid stored in the storage unit to an outside, and a protective member capable of being assembled to one end portion of the storage member, wherein the protective member contains a recycled plastic material or a resin material mixed with a recycled plastic material, and has an opening configured to expose the supply unit, and wherein as the liquid storage container is viewed from a side on which the supply unit is provided, a bent portion is provided on a first side surface that is farthest from the supply unit exposed through the opening among side surfaces of the protective member.

Further features of the present invention will become apparent from the following description of exemplary embodiments with reference to the attached drawings.

### BRIEF DESCRIPTION OF THE DRAWINGS

FIG. 1 is a perspective view of an inkjet recording apparatus.

FIG. 2 is a perspective view of an ink tank.

FIG. 3 is a perspective view of a tank cover.

FIG. 4 is a perspective view of the tank cover.

FIG. 5 is a front view of the tank cover.

### DESCRIPTION OF THE EMBODIMENTS

When recycled plastic materials are used as the materials for liquid storage containers, the recycled plastic materials tend to be lower in impact strength than virgin materials as described above. In particular, when a liquid storage container has a protruding portion on its end side as discussed in Japanese Patent Application Laid-Open No. H10-16249, if the container is accidentally dropped and the protruding portion on the end side receives a direct impact, the protruding portion may become chipped or broken.

As a result, the connection with the inkjet recording apparatus may become unstable.

The present disclosure is directed to maintaining high impact strength of recycled plastic materials even when they are used for liquid storage containers.

Hereinafter, preferred exemplary embodiments of the present disclosure will be described in detail with reference to the accompanying drawings. The following exemplary embodiments do not limit the present disclosure, and not all combinations of described features of the following exemplary embodiments are necessarily essential to the solution of the present disclosure. The same components are given the same reference numbers. The usage of a liquid storage container here will be described by taking as an example a case where a liquid discharge apparatus (inkjet recording apparatus) is refilled with a liquid (ink). However, the usage of the liquid storage container is not limited to this example. The liquid stored in the liquid storage container is not limited to ink, and may be a predetermined processing liquid, for example.

The term recycled plastic material in the exemplary embodiments is used in a broad sense, including a post-consumer material (PCR material) and a pre-consumer material. The PCR material is a material obtained by collecting and reusing plastic products after distribution to the market. For example, the PCR material is a plastic prepared from cleaned and crushed waste products. The PCR material may be thermoplastic prepared from waste industrial plastic by an operator other than the first processor. The pre-consumer material is a material obtained by collecting and reusing waste plastic generated in the manufacturing process before distribution to the market. For example, the pre-consumer material is a thermoplastic prepared from offcuts or rejected molded products that are processed in advance by molding, extrusion, and the like at the processor's factory and then reprocessed at the same factory. In the present exemplary embodiment, the recycled plastic material may be a PCR material or a pre-consumer material. It may also be a mixture of both. That is, in the present exemplary embodiment, it is sufficient to use a recycled plastic material or a resin material mixed with a recycled plastic material.

The recycled plastic material used in the present exemplary embodiment can be one that has been determined as being suitable for use based on the size of contamination. For example, a thin sample plate is molded, and if the size of the contamination on the surface of the sample plate is less than a predetermined value, the plate is determined as being suitable for use. The predetermined value is 1 mm², for example. This is a mere example and the predetermined value is not limited to this example.

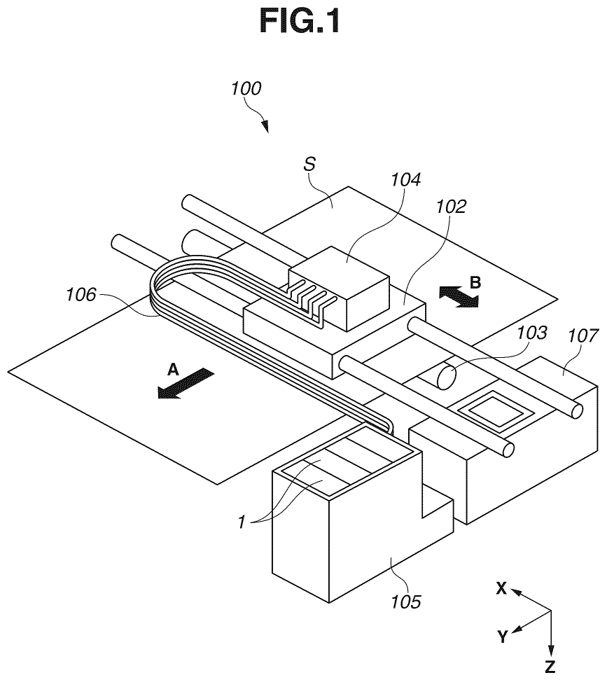

FIG. 1 is a perspective view of an inkjet recording apparatus 100 that is a liquid discharge apparatus using a liquid supply system according to the present exemplary embodiment. Referring to FIG. 1, the inkjet recording apparatus 100 is configured to discharge ink from a recording head 104 onto a recording medium S based on image data to record an image (including characters or symbols). The recording head 104 is mounted on a carriage 102. In a recording operation, the recording medium S is conveyed by a conveyance roller 3 in a conveyance direction (sub-scanning direction) indicated by arrow A, and the carriage 102 is moved back and forth in a direction (main scanning direction) indicated by arrow B, intersecting the sub-scanning direction. Ink is discharged from the recording head 104 onto the recording medium S by driving the recording head 104 based on image data in synchronization with the movement of the carriage 102. The recording medium S is conveyed by a conveyance roller 107 at a predetermined pitch, and recording on the entire recording medium is performed by alternately repeating conveyance at a predetermined pitch and recording for one line. As the recording medium S, various materials as described above can be used, and typically, a sheet-like material such as recording paper or a plastic sheet is used.

The recording head 104 has a discharge port array that is composed of a plurality of discharge ports arranged in series in the sub-scanning direction on the discharge surface facing the recording medium S. A plurality of discharge port arrays is provided in correspondence with the number of types of ink used. In color recording or gradation recording, a desired image is formed by discharging different types of ink from the discharge port arrays. The ink is supplied to the recording head 104 through ink supply paths 106 such as tubes from an ink supply unit 105 in which a plurality of ink tanks 1 for color ink is detachably attached. FIG. 1 illustrates an example in which the ink tanks 1 are provided for four colors, but the ink tanks 1 are not limited to this example, and may be provided for three or less colors, five or more colors, or one color. In addition, the ink tanks 1 may be configured to store a liquid other than ink.

The inkjet recording apparatus 100 of the present exemplary embodiment is a serial scanning printer, which as described above, records an image through scanning by the recording head 104 in the main scanning direction (X direction) orthogonal to the conveyance direction (Y direction) in which the recording medium S is conveyed. The inkjet recording apparatus 100 may have a line-type recording head in which the discharge ports extend across the width direction (X direction) of the recording medium S.

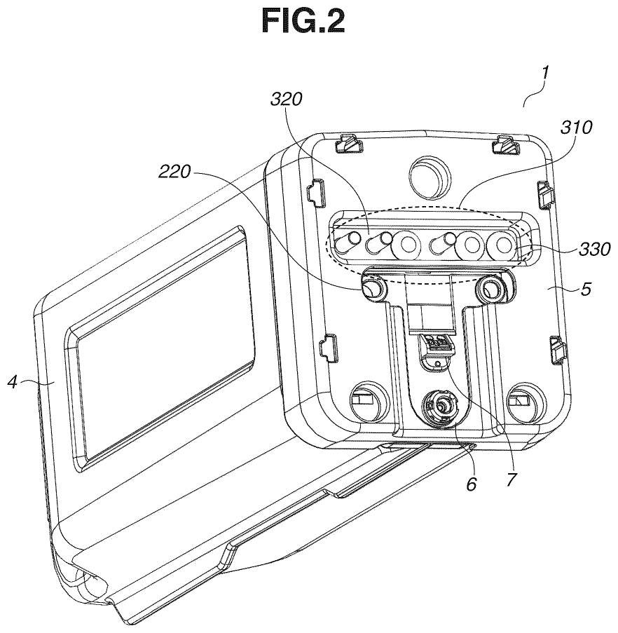

FIG. 2 is a perspective view of the ink tank 1 according to the present exemplary embodiment. The ink tank 1 that is a liquid storage container stores, as a liquid, pigment ink of colors that match the configuration of the recording apparatus (for example, black, cyan, magenta, and yellow). The ink tank 1 has a tank exterior 4 as a storage member that stores a liquid, and a tank cover (protective member) 5 that is capable of being assembled to one end of the tank exterior 4. FIG. 2 illustrates a state in which the tank cover 5 is assembled to the ink tank 1. The tank exterior 4 of the ink tank 1 is molded by injection-blow molding using a virgin resin such as a polypropylene (PP) material or a polyethylene (PE) material. The components of the ink tank 1 are assembled using a technique such as ultrasonic welding, heat welding, adhesion, or fitting.

The tank exterior 4 functions as a storage member (ink storage unit) that stores a liquid.

The ink tank 1 of the present exemplary embodiment has an ink capacity of about 2,500 ml. The tank exterior 4 has a substantially rectangular parallelepiped shape. The ink tank 1 of the present exemplary embodiment is detachably attached to a fixed part (not illustrated) of the inkjet recording apparatus 100.

The ink tank 1 is formed with an ink connection port (supply unit) 6 for drawing out ink and a positioning unit 220 for positioning the ink tank 1 with respect to needles (not illustrated) on the inkjet recording apparatus. In the present exemplary embodiment, the ink connection port 6 and the positioning unit 220 are arranged on a side of the ink tank 1 that is illustrated as the front side in the direction of attachment to the inkjet recording apparatus 100. On the outer wall of the tank cover 5, an improper attachment prevention unit 310 is arranged on the front side of the ink tank 1 in the attachment direction to prevent the ink tank 1 from being attached at a wrong position on the inkjet recording apparatus 100. In the example illustrated in FIG. 2, the improper attachment prevention unit 310 includes six cylindrical identification pins 320 that protrude from the outer wall of the tank cover 5. Referring to FIG. 2, some of the identification pins 320 are in a thermally fixed state. In the present exemplary embodiment, the identification pins 320 preferably have a circular cylindrical shape. The number of identification pins 320 may be any number more than one. The shape of the identification pins 320 is not limited to the above example and can be changed to various shapes.

The ink tank 1 can be prepared by injection molding or blow molding using a mold.

In this case, it is preferable to use a thermoplastic resin as the material for forming the ink tank 1. All the identification pins 320 except for at least one, illustrated in FIG. 2, are thermally melted to form the improper attachment prevention unit 310. Because some of the identification pins 320 are crushed by thermal processing, the improper attachment prevention unit 310 has one or more identification pins 320 and processed portions 330 crushed by the thermal processing. In the example illustrated in FIG. 2, the processed portions 330 are formed by crushing the third, fifth, and sixth identification pins 320 from the left by thermal processing. The processed portions 330 are integrated with the outer wall of the inkjet recording apparatus 100 because the identification pins 320 are crushed so as to decrease in height and increase in diameter. The identification pins 320 in the first exemplary embodiment are melted and crushed by applying heat. Considering the time and ease of thermal processing, the identification pins 320 preferably have a hollow cylindrical shape. In another exemplary embodiment, the identification pins 320 may have a solid cylindrical shape. However, the shape of the identification pins 320 is not limited to this example, and may have various shapes such as a cone or a square prism. As an example, the identification pins 320 have a hollow cylindrical shape with a height of 13.5 mm, a diameter of φ5 mm, and a wall thickness of 0.7 mm. The thermal processing can be performed by a thermal welding machine (impulse welder) as a thermal processing means. The processing horn of the thermal welding machine used in the present exemplary embodiment has a diameter of φ8 mm and a recess height of 1.6 mm on the processing surface. The processing horn preferably supplies heat to the identification pins 320 while pressing the identification pins 320 from the tips of the identification pins 320 toward the outer wall of the inkjet recording apparatus 100.

The tank cover 5 is configured to protect the functional parts of the ink tank 1, such as the ink connection port 6 and an electrical connection unit 7, from external impact. If the ink tank 1 is accidentally dropped and subjected to a direct impact, this may lead to cracks in the functional parts. Thus, the tank cover 5 is preferably structured to protect the functional parts from such external impact. On the other hand, because it is necessary for the functional parts such as the ink connection port 6 to be connectable to the inkjet recording apparatus 100, the tank cover 5 has an opening 10 so that the functional parts, such as the ink connection port 6 and the electrical connection unit 7, are exposed through the opening 10.

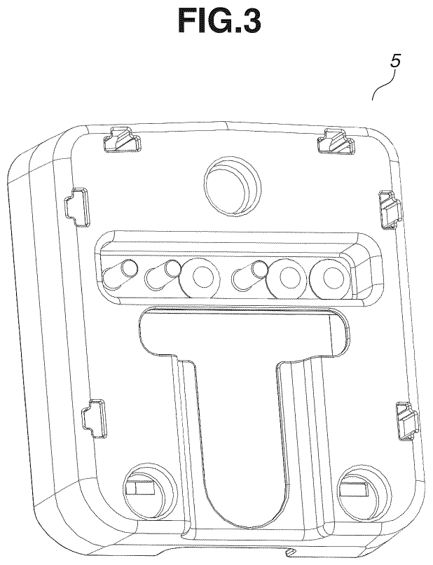

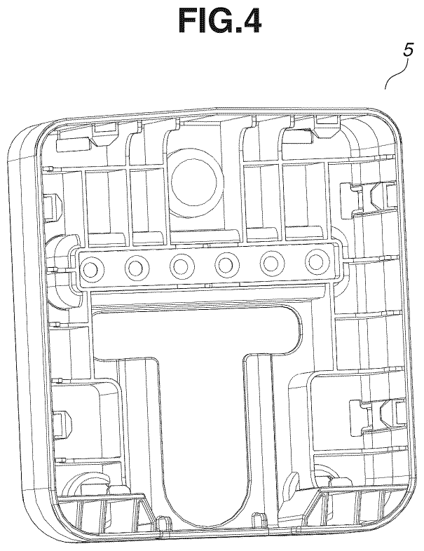

FIG. 3 is a perspective view of the tank cover 5 as seen from the end side of the ink tank 1, and FIG. 4 is a perspective view of the tank cover 5 as seen from the tank exterior 4 side. The tank cover 5 is made of a post-consumer material (PCR material) that is a copolymer resin material of acrylonitrile, butadiene, and styrene (hereinafter, also referred to as “ABS material”). As physical property values of this PCR material, the Charpy impact value is preferably 18 KJ/m² or more and 25 KJ/m² or less, the melt flow rate (MFR) value is preferably about 16 g/10 min, and the flexural modulus is preferably about 2400 MPa. Regarding the Charpy impact value, the value of the virgin material is about 27 KJ/m², and generally, the PCR material may be lower than the virgin material. However, the PCR material is not limited to an ABS material, and may be a polyethylene (PE) material or a polypropylene (PP) material.

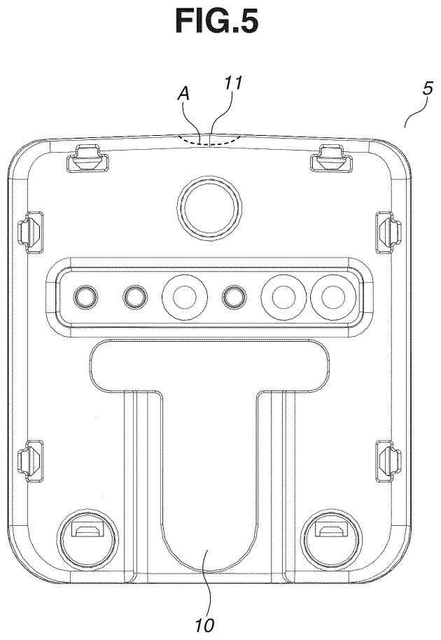

FIG. 5 is a front view of the ink tank 1 as seen from the end side. As illustrated in FIG. 5, the tank cover 5 has the opening 10 through which the ink connection port 6 and the electrical connection unit 7 are exposed, and has a bent portion 11 on the side far from the opening 10. The bent portion 11 is preferably bent in a direction away from the ink connection port 6 and the like. That is, among the side surfaces of the tank cover 5, the center portion of the side surface (first side surface) farthest from the ink connection port 6 exposed through the opening 10 has a convex shape in the direction farther away from the ink connection port 6 than the end portion. The bent portion 11 tends to be subjected to a concentrated load in the event of an external impact, and is likely to become cracked. That is, the bent portion 11 actively absorbs an external impact, and as a result, suppresses the effect of the external impact on the portions close to the functional parts such as the ink connection port 6 and the electrical connection unit 7.

The bent portion 11 preferably has an inner angle A of 175 degrees or more and less than 180 degrees, and more preferably has an inner angle A of 175 degrees or more and 177 degrees or less. In the present exemplary embodiment, the inner angle A of the bent portion 11 is about 176 degrees. One bent portion 11 may be provided as illustrated in FIG. 5, or a plurality of bent portions 11 may be provided.

As physical property values of the recycled plastic material, the Charpy impact value is preferably 15 KJ/m² or more, and the MFR value is preferably 10 g/10 min or more and 20 g/10 min or less. From the viewpoint of further enhancing the effect of suppressing cracking due to a drop impact, the flexural modulus is preferably 2000 MPa or more and 3000 Mpa or less.

The technologies described in this specification have the potential to contribute to the achievement of a sustainable society, such as a decarbonized society/circular society.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-005270, filed Jan. 17, 2024, which is hereby incorporated by reference herein in its entirety.

1. A liquid storage container comprising:
a storage member having a storage unit for storing a liquid and a supply unit for supplying the liquid stored in the storage unit to an outside; and
a protective member capable of being assembled to one end portion of the storage member,
wherein the protective member contains a recycled plastic material or a resin material mixed with a recycled plastic material, and has an opening configured to expose the supply unit, and
wherein as the liquid storage container is viewed from a side on which the supply unit is provided, a central portion of a first side surface that is farthest from the supply unit exposed through the opening among side surfaces of the protective member has a convex shape in a direction farther away from the supply unit than an end portion.

2. The liquid storage container according to claim 1, wherein as the liquid storage container is viewed from the side on which the supply unit is provided, a second side surface that is closest to the supply unit exposed through the opening among the side surfaces of the protective member faces the first side surface.

3. The liquid storage container according to claim 1, wherein the recycled plastic material has a Charpy impact value of 15 KJ/m2 or more.

4. The liquid storage container according to claim 1, wherein the recycled plastic material has an MFR value of 10 g/10 min or more and 20 g/10 min or less.

5. The liquid storage container according to claim 1, wherein the recycled plastic material has a flexural modulus of 2000 MPa or more and 3000 MPa or less.

6. The liquid storage container according to claim 1, wherein the recycled plastic material has a Charpy impact value of 15 KJ/m2 or more, an MFR value of 10 g/10 min or more and 20 g/10 min or less, and a flexural modulus of 2000 MPa or more and 3000 MPa or less.

7. The liquid storage container according to claim 1, wherein the recycled plastic material contains any of a polyethylene material, a polypropylene material, and a copolymer resin material of acrylonitrile, butadiene, and styrene.

8. The liquid storage container according to claim 1, wherein the recycled plastic material contains a copolymer resin material of acrylonitrile, butadiene, and styrene.

9. A liquid storage container comprising:
a storage member having a storage unit for storing a liquid and a supply unit for supplying the liquid stored in the storage unit to an outside; and
a protective member capable of being assembled to one end portion of the storage member,
wherein the protective member contains a recycled plastic material or a resin material mixed with a recycled plastic material, and has an opening configured to expose the supply unit, and
wherein as the liquid storage container is viewed from a side on which the supply unit is provided, a bent portion is provided on a first side surface that is farthest from the supply unit exposed through the opening among side surfaces of the protective member.

10. The liquid storage container according to claim 9, wherein as the liquid storage container is viewed from the side on which the supply unit is provided, the bent portion of the first side surface is bent in the direction away from the supply unit.

11. The liquid storage container according to claim 9, wherein as the liquid storage container is viewed from the side on which the supply unit is provided, the bent portion has an inner angle of 175 degrees or more and less than 180 degrees.

12. The liquid storage container according to claim 9, wherein as the liquid storage container is viewed from the side on which the supply unit is provided, the bent portion has an inner angle of 175 degrees or more and 177 degrees or less.

13. The liquid storage container according to claim 9, wherein as the liquid storage container is viewed from the side on which the supply unit is provided, a second side surface that is closest to the supply unit exposed through the opening among the side surfaces of the protective member faces the first side surface.

14. The liquid storage container according to claim 9, wherein the recycled plastic material has a Charpy impact value of 15 KJ/m² or more.

15. The liquid storage container according to claim 9, wherein the recycled plastic material has an MFR value of 10 g/10 min or more and 20 g/10 min or less.

16. The liquid storage container according to claim 9, wherein the recycled plastic material has a flexural modulus of 2000 MPa or more and 3000 MPa or less.

17. The liquid storage container according to claim 9, wherein the recycled plastic material has a Charpy impact value of 15 KJ/m² or more, an MFR value of 10 g/10 min or more and 20 g/10 min or less, and a flexural modulus of 2000 MPa or more and 3000 MPa or less.

18. The liquid storage container according to claim 9, wherein the recycled plastic material contains any of a polyethylene material, a polypropylene material, and a copolymer resin material of acrylonitrile, butadiene, and styrene.

19. The liquid storage container according to claim 9, wherein the recycled plastic material contains a copolymer resin material of acrylonitrile, butadiene, and styrene.
